(19) United States
(12) Patent Application Publication
(10) Pub. No.: US 2009/0075076 A1
(43) Pub. Date: Mar. 19, 2009

(54) IMPACT RESISTANT STRAIN HARDENING BRITTLE MATRIX COMPOSITE FOR PROTECTIVE STRUCTURES

(75) Inventors: VICTOR C. LI, Ann Arbor, MI (US); En-Hua Yang, Houston, TX (US)

Correspondence Address: HARNESS, DICKEY & PIERCE, P.L.C., P.O. BOX 828, BLOOMFIELD HILLS, MI, 48303, US

(73) Assignee: The Regents of the University of Michigan, Ann Arbor, MI (US)

(21) Appl. No.: 12/208,714

(22) Filed: Sep. 11, 2008

Related U.S. Application Data
(60) Provisional application No. 60/972,030, filed on Sep. 13, 2007.

(51) Int. Cl. B32B 5/02

(52) U.S. Cl. 428/359

(57) ABSTRACT

An extremely ductile fiber reinforced brittle matrix composite is of great value to protective structures that may be subjected to dynamic and/or impact loading. Infrastructures such as homes, buildings, and bridges may experience such loads due to hurricane lifted objects, bombs, and other projectiles. Compared to normal concrete and fiber reinforced concrete, the invented composite has substantially improved tensile strain capacity with strain hardening behavior, several hundred times higher than that of conventional concrete and fiber reinforced concrete even when subjected to impact loading. The brittle matrix may be a hydraulic cement or an inorganic polymer. In an exemplary embodiment of the teachings, the composites are prepared by incorporating pozzolanic admixtures, lightweight filler, and fine aggregates in Engineered Cementitious Composite fresh mixture, to form the resulting mixtures, then placing the resulting mixtures into molds, and curing the resulting mixtures.

### CROSS-REFERENCE TO RELATED APPLICATIONS

This application claims the benefit of U.S. Provisional Application No. 60/972,030 filed on Sep. 13, 2007. The entire disclosure of the above application is incorporated herein by reference.

### FIELD

The present teachings relate to a fiber reinforced brittle matrix composite, and more particularly, to a fiber reinforced brittle matrix composite that exhibits strain hardening behavior in tension and maintains a tensile ductility at least 1% even when subjected to impact loading.

### BACKGROUND AND SUMMARY

The statements in this section merely provide background information related to the present disclosure and may not constitute prior art.

Terrorist attacks and natural hazards highlight the need for assuring human safety in large structures under extreme loading such as bomb blasts and flying object impacts. While concrete has served as an eminently successful construction material for many years, reinforced concrete structure can be vulnerable under severe dynamic loading. The collapse of a large portion of the Alfred P. Murrah Federal Building in Oklahoma City in 1996, for example, demonstrates the vulnerability of reinforced concrete structure when subjected to bomb blasts.

Many catastrophic failures of reinforced concrete structures subjected to blast/impact are associated with the brittleness of concrete material in tension. Although a compressive stress wave is generated on the loading side of the structure by impact/blast, it reflects as a tensile stress wave after hitting a free boundary on the back side of the structural element. In addition, the tensile strength of concrete is typically much lower (by about an order of magnitude) than its compressive strength. Therefore, concrete tensile properties generally govern concrete failure under impact/blast as suggested by Malvar and Ross. Brittle failures, such as cracking, spalling, and fragmentation, of concrete are often observed in reinforced concrete structures when subjected to blast/impact, and can lead to severe loss of structural integrity. Apart from that, high speed spalling debris ejected from the back side of the structural elements can cause serious injury to personnel behind the structural elements.

Extensive research has been conducted on impact/blast response of reinforced concrete structural elements and mitigation design of reinforced concrete structure against impact/blast loading. Current practice, such as thickening the dimension of structural members, increasing the amount of steel reinforcement, special reinforcement detailing, installing additional shear walls etc., places emphasis on structural design and detailing, and/or adding redundancy to reduce the chance of progressive collapse after an attack. An alternative solution to resolve some of the above mentioned challenges is to embed tensile ductility intrinsically into the concrete material. Ductile concrete would be highly desirable to suppress the brittle failure modes and enhance the efficiency and performance of current design approaches. The most effective means of imparting ductility into concrete is by means of fiber reinforcement.

While the fracture toughness of concrete is significantly improved by fiber reinforcement, most fiber reinforced concrete still shows quasi-brittle post-peak tension-softening behavior under tensile load where the load decreases with the increase of crack opening. The tensile strain capacity therefore remains low, about the same as that of normal concrete, i.e. about 0.01%. Significant efforts have been made to convert this quasi-brittle behavior of fiber reinforced concrete to ductile strain hardening behavior resembling ductile metal. In most instances, the approach is to increase the volume fraction of fiber as much as possible. As the fiber content exceeds a certain value, typically 4-10% depending on fiber type and interfacial properties, the conventional fiber reinforced concrete may exhibit moderate strain hardening behavior. For example, French Patent WO 99/58468, awarded to the Assignees Bouygues, Lafarge and Rhodia Chimie, discloses a high performance concrete comprising organic fibers dispersed in a cement matrix, wherein the matrix is highly compacted by using very hard, small diameter fillers to achieve high strength. Moderate strain hardening behavior is achieved with strain capacity less than 0.5%, when 4% polyvinyl alcohol fiber by volume fraction is added.

High volume fraction of fiber, however, results in considerable processing problems. Fiber dispersion becomes difficult because of high viscosity of the mix due to the presence of high surface area of the fibers and the mechanical interaction between the fibers, along with the difficulties in handling and placing. Various processing techniques have been proposed to overcome the workability problem. For example, U.S. Pat. No. 5,891,374 to Shah et al., discloses using extrusion process to produce fiber reinforced cementitious composite with strain hardening behavior in tension wherein more than 4% fiber by volume fraction is used. The tensile strain capacity of such extruded composites remains below 1%.

The present teachings provide a new class of strain hardening cementitious composites: Engineered Cementitious Composite featuring low fiber content typically less than 3% by volume and high strain capacity typically in excess of 3%. The design of engineered cementitious composite is based on the understanding in the micromechanics of strain hardening in cementitious composites reinforced with short randomly distributed fibers. The fiber, matrix and interface are carefully selected and tailored based on the micromechanics model to ensure that the composite behaves strain hardening in tension at low fiber content when subjected to quasi-static loading. The mix maintains favorable workability and can be handled and placed like normal concrete.

Similar to concrete and many other engineering materials, engineered cementitous composite has mechanical properties which exhibit rate dependency. FIG. 1a plots the tensile stress-strain curve of engineered cementitous composite M45, the most widely studied version of engineered cementitous composite in current engineering practice, subjected to different strain rates. The strain rate ranges from 10⁻⁵ to 10⁻¹ s⁻¹, corresponding to quasi-static loading to low speed impact. A descending trend of tensile ductility with increasing strain rate was found for M45 as depicted in FIG. 1b. Tensile ductility reduces from 3% to 0.5% at the highest strain rate. Both first cracking strength and ultimate tensile strength were found to increase with increasing strain rate.

Accordingly, the present teachings provide a method of making a fiber reinforced brittle matrix composite having substantially improved tensile strain capacity with strain hardening behavior even when subjected to impact loading. The fibers used in the composite are tailored to work with a mortar matrix in order to suppress localized brittle fracture in favor of distributed microcrack damage. The composite comprises hydraulic cement or inorganic polymer binder, water, water reducing agent, and short discontinuous fiber are mixed to form a mixture having reinforcing fiber uniformly dispersed and having preferable flowability. Optional ingredients including fine aggregates, pozzolanic admixtures, and lightweight fillers, are also used in some mix design. The mixture is then cast into a mold with desired configuration and cured to form composite.

In some embodiments, the present teachings can provide a means of achieving high tensile strain capacity in a fiber reinforced brittle matrix composite when subjected to static and up to impact loading by controlling the synergistic interaction among fiber, matrix and interface. A feature of the teachings is the use of micromechanics parameters that describe fiber, matrix, and interface properties to differentiate acceptable fiber cement system from unacceptable fiber cement system.

In some embodiments, the present teachings can provide selection criteria for reinforcing fibers, matrix, and interface to be used in production of fiber reinforced brittle matrix composite that strain-hardens in tension at low fiber content.

In some embodiments, the present teachings can provide fiber reinforced brittle matrix products having substantially improved tensile strain capacity with strain hardening behavior even when subjected to impact loading, compared with the respective properties of the other fiber reinforced concrete and reinforced by carbon, cellulose, or polypropylene fiber.

In some embodiments, the present teachings can provide a ductile material for protective structure in construction applications.

In practicing some embodiment of the present teachings, the binder preferably comprises a hydraulic cement, such as Type I Portland cement. The fine aggregates is silica sand with a size distribution up to 250 μm and the pozzolanic admixtures is Class F fly ash. The weight ratio of water to binder is within the range of 0.2 to 0.6. The discontinuous reinforcing fiber is polyvinyl alcohol with a diameter in the range of 30-60 micrometer and is present from about 1.5% to 3.0% by volume of the composite.

In some embodiments, the present teachings can provide a ductile fiber reinforced brittle matrix composite exhibiting significant multiple cracking when stressed in tension with at least 1% tensile strain when subjected to static and up to impact loading.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 depicts rate dependency in engineered cementitous composite M45 (a) tensile stress-strain curve and (b) tensile ductility at four different strain rates.

FIG. 2 depicts Typical σ(δ) curve for tensile strain hardening composite. Hatched area represents complimentary energy J′_{b}. Gray area represents crack tip toughness Jₜᵢₚ.

FIG. 3 depicts tensile stress-strain curves of Mix 1 subjected to three different strain rates.

FIG. 4 depicts tensile stress-strain curves of Mix 2 subjected to three different strain rates.

FIG. 5 depicts tensile stress-strain curves of Mix 3 subjected to two different strain rates.

FIG. 6 depicts tensile stress-strain curves of Mix 4 subjected to two different strain rates.

FIG. 7 depicts tensile stress-strain curves of Mix 5 subjected to three different strain rates.

FIG. 8a depicts mortar plate after the 2^{nd} impact (cracking & fragmentation).

FIG. 8b depicts back side of Mix 1 plate after 10 impacts (fine cracks only).

FIG. 9 shows the load-deformation curve of concrete, Mix 1, reinforced concrete, and R/Mix 1 beams.

FIG. 10 shows the damage of reinforced concrete and R/Mix 1 after impact testing.

FIG. 11 summarizes the load capacity of reinforced concrete and R/Mix 1 beams in each impact.

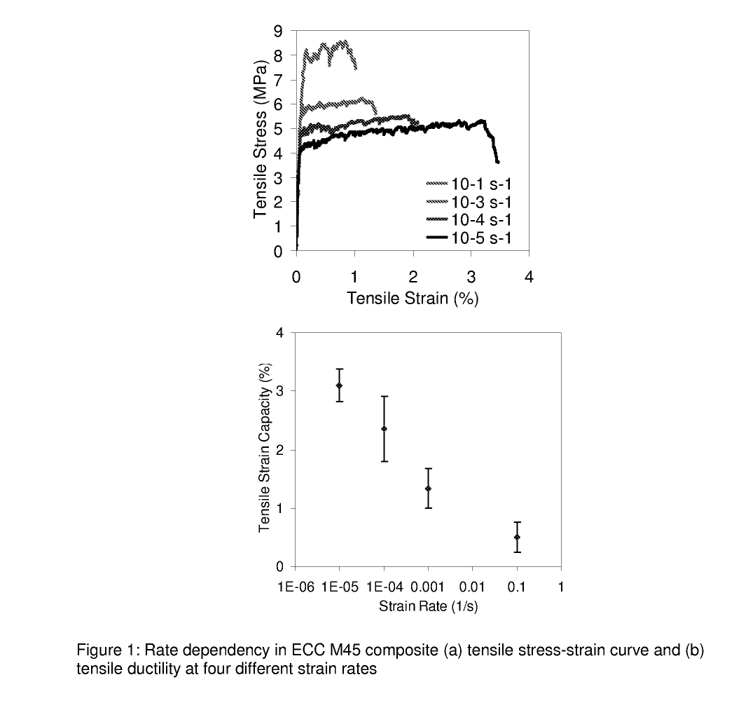

### DETAILED DESCRIPTION

The following description is merely exemplary in nature and is not intended to limit the present disclosure, application, or uses. It should be understood that throughout the drawings, corresponding reference numerals indicate like or corresponding parts and features.

Practice of the present teachings involves providing a cementitious or inorganic polymeric mixture comprising selected constituents appropriate for producing a ductile fiber reinforced brittle matrix composite to improve impact resistance of structures. The resulting composite has good workability capable of pumping, spraying and casting like normal concrete. Guideline based on micromechanics consideration is also provided to select suitable matrix ingredients and discontinuous short fiber, wherein selection criteria are quantified by several micromechanics characteristics. Having high strain capacity and energy absorption capability the material is suitable for use in civil and military protective structure or other applications when dynamic and/or impact loading is of great concern.

The mixture typically comprises hydraulic cement, water, and discontinuous short fibers in proportions. Other optional constituents, such as fine aggregates, pozzolanic admixtures, and lightweight fillers, are also used in some mix design. Water reducing agent and/or viscosity control agent are often needed to adjust rheology to achieve uniform dispersion of fibers. The selection of the mixture constituents will depend on the mechanical performance that is desired for a particular application, and the employed material processing method desired.

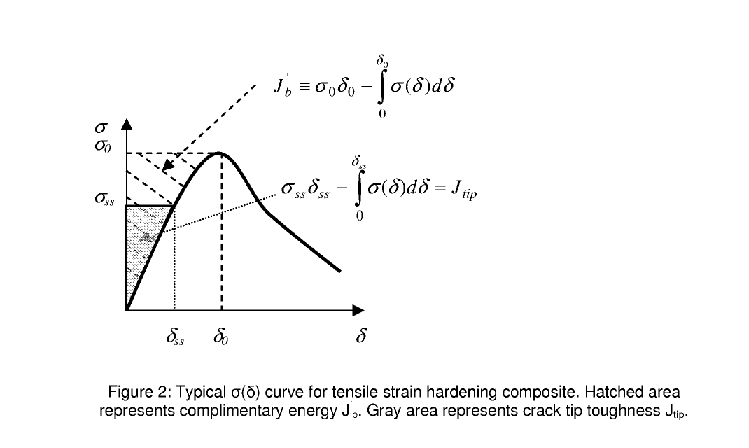

The design of a composite with aforementioned advantages is based on the understanding of the mechanical interactions between fiber, matrix, and interface phases, which can be quantified by micromechanics models. The fundamental requirement is that steady state flat crack propagation prevails under tension, which requires the crack tip toughness Jₜᵢₚ to be less than the complementary energy J′_{b} calculated from the bridging stress σ versus crack opening δ curve, as illustrated in FIG. 2.

$$\begin{matrix}{J}_{tip} \leq {σ}_{0} {δ}_{0} - {\int }_{0}^{{δ}_{0}} σ ( δ ) d δ ≡ {J}_{b}^{′} & ( 1 ) \\ {J}_{tip} = \frac{{K}_{m}^{2}}{{E}_{m}} & ( 2 )\end{matrix}$$

where σ₀ is the maximum bridging stress corresponding to the opening δ₀, Kₘ is the matrix fracture toughness, and Eₘ is the matrix Young's modulus.

The stress-crack opening relationship σ(δ), which can be viewed as the constitutive law of fiber bridging behavior, is derived by using analytic tools of fracture mechanics, micromechanics, and probabilistics. As a result, the σ(δ) curve is expressible as a function of micromechanics parameters, including interface chemical bond G_{d}, interface frictional bond τ₀, and slip-hardening coefficient β accounting for the slip-hardening behavior during fiber pullout. In addition, snubbing coefficient f and strength reduction factor f′ are introduced to account for the interaction between fiber and matrix as well as the reduction of fiber strength when pulled at an inclined angle. Besides interface properties, the σ(δ) curve is also governed by the matrix modulus Eₘ, fiber content V_{f}, and fiber diameter d_{f}, length L_{f}, strength σ_{f}, and modulus E_{f}.

Another condition for engineered cementitous composite strain hardening is that the matrix tensile cracking strength σ_{cs} must not exceed the maximum fiber bridging strength σ₀.

σ_{cs}<σ₀ (3)

where σ_{cs} is determined by the matrix fracture toughness Kₘ and pre-existing internal flaw size a₀. While the energy criterion (Eqn. 1) governs the crack propagation mode, the strength-based criterion represented by Eqn. 3 controls the initiation of cracks. Satisfaction of both Eqn. 1 and 3 is necessary to achieve engineered cementitous composite behavior; otherwise, normal tension-softening fiber reinforced concrete behavior results. Details of these micromechanical analyses can be found in previous works.

Due to the randomness nature of preexisting flaw size and fiber distribution in engineered cementitous composite, a large margin between J′_{b} and Jₜᵢₚ (i.e. large J′_{b}/Jₜᵢₚ ratio) and a large margin between σ₀ and σ_{cs} (i.e. large σ₀/σ_{cs} ratio) are preferred. Materials with larger J′_{b}/Jₜᵢₚ and σ₀/σ_{cs} should have a better chance of saturated multiple cracking. The saturation of multiple cracking is achieved when microcracks are more or less uniformly and closely spaced (at around 1-2 mm), and cannot be further reduced under additional tensile loading of a uniaxial tensile specimen.

Parametric studies based on the foregoing models produces a set of targeted micromechanical property value ranges, which provide guidance to the selection of mixture constituents for achieving strain hardening behavior. The following ranges of fiber, matrix and interfacial properties are preferred: fiber strength at least 800 MPa, fiber diameter from 20 to 100 μm and more preferably from 30 to 60 μm, fiber modulus of elasticity from 10 to 300 GPa and more preferably from 40 to 200 GPa, and fiber length from 4 to 40 mm that is partially constrained by processing restriction; matrix toughness below 5 J/m² and more preferably below 2 J/m²; interface chemical bonding below 2.0 J/m² and more preferably below 0.5 J/m², interface frictional stress from 0.5 to 3.0 MPa and more preferably from 0.8 to 2.0 MPa, and interface slip hardening coefficient below 3.0 and more preferably below 1.5.

All these fiber and interface properties can be determined prior to forming composite. The interfacial properties can be characterized by a single fiber pullout test, while the fiber properties are usually found in specifications from fiber manufacturer.

A variety of commercially available discontinuous short fibers can be used in practicing the teachings, following the aforementioned guidance. For purpose of illustration and not limitation, the reinforcing fibers can be selected from a group consisting of aromatic polyamide (i.e. aramid) fiber, high modulus polyethylene, polyvinyl alcohol, and high tenacity polypropylene. Other fibers that do not satisfy these criteria include carbon fibers, cellulose fibers, low-density polyethylene fibers, certain polypropylene fibers, and steel fibers.

While the conventional approach to achieve strain hardening in fiber reinforced composites is to use high content of fiber typically at 4 to 20%, the teachings feature a rather low volume fraction typically at 1 to 3%. For purpose of illustration, 2% volume fraction of fiber is used in the Examples. The lower fiber content makes it feasible for various types of processing, including but not limited to casting, extrusion, or spray. The lower fiber content also enhances economic feasibility for infrastructure construction applications.

The matrix of the composite is composed of a binder comprising of hydraulic cement. The hydraulic cement refers to cement that sets and hardens in the presence of water, which includes but not limited to a group consisting of Portland cement, blended Portland cement, expansive cement, rapid setting and hardening cement, calcium aluminate cement, magnesium phosphate and the mixture thereof. One exemplary type of cement used in the practice of the teachings is Type I Portland cement. Pozzolanic admixtures such as fly ash and silica fume can also be included in the mixture.

Water is present in the fresh mixture in conjunction with viscosity control agent and water reducing agent to achieve adequate rheological properties. The preferred weight ratio of water to binder is 0.2 to 0.6. Viscosity control agent can be used to prevent segregation and to help achieve better fiber dispersion. Water reducing agent is used to adjust workability after the water content in the composite is determined, and the quantity needed varies with the water to cement ratio, the type of lightweight filler and the type of water reducing agent. An illustrative water reducing agent comprises superplasticizer available as ADVA Cast 530 from W. R. Grace & Co., IL, USA, and the typical amount used in practicing the teachings is about 0.001 to 0.002 in weight ratio of the water reducing agent to cement.

The mix preparation of the teachings can be practiced in any type of concrete or mortar mixer, following conventional fiber reinforced concrete mixing procedure. Fibers can either be added at the end when a consistent matrix paste has been reached, or be premixed with dry powders to form a pre-package mortar. Since the workability and rheology can be adjusted in broad range, the fresh mixture can be pumped, cast or sprayed according to construction requirement.

The obtained composite has significantly improved ductility with strain hardening behavior that is hundreds of times higher than that of conventional concrete and fiber reinforced concrete when subjected to static and up to impact loading. Having strength similar to normal concrete, the obtained composite is suitable for protective structure application or other applications where high energy absorption capacity and large deformation are required when subjected to dynamic and impact loading. The high tensile ductility of this invented material will further suppress commonly observed concrete fragmentation and provide safety to occupants of homes and buildings under projectile loading.

Embodiment of the teachings is illustrated through the following examples, which by no means is intended to be limitative thereof.

### EXAMPLES

The exemplary mixes here below for preparing ductile fiber reinforced brittle matrix composite comprises cement, fine aggregates, pozzolanic admixtures, lightweight fillers, water, water reducing agent, and discontinuous short fibers. The mix proportions are tabulated in Table 1. The cement used is Type I Portland cement from Holcim Cement Co., MI, USA. The water reducing agent used is superplasticizer available as ADVA Cast 530 from W. R. Grace & Co., IL, USA. Two types of discontinuous polymer fibers, K-II REC™ polyvinyl alcohol (PVA) fiber through Kuraray Co. Ltd of Osaka, Japan, and Spectra 900 high strength high modulus polyethylene (PE) fiber through Honeywell Inc., USA, are used at 2% volume fraction. The properties of the PVA and PE fibers can be found in Table 2. Pozzolanic admixture used is a low calcium Class F fly ash from Boral, Tex., USA. Two types of fine aggregate, silica sand and recycled corbitz sand, are used. The silica sand with a size distribution from 50 to 250 μm, available as F110 through US Silica Co., MV, USA, is used in some mixes. Corbitz is a byproduct from chemically bonded lost foam sand casting techniques and often contains high amount of carbon particles. Lightweight filler used is a commercially available glass bubble, Scotchlite™ S60, from 3M Co., Minnesota, USA.

TABLE 1
Mix proportions of Examples, parts by weight

| Mix | | | | Corbitz | Fly | Glass | | PE Fiber | PVA Fiber |
|---|---|---|---|---|---|---|---|---|---|
| No. | Cement | Water | Sand | Sand | Ash | Bubble | SP | by volume | by volume |
| 1 | 1 | 1 | 1.4 | 0 | 2.8 | 0 | 0.013 | 0 | 0.02 |
| 2 | 1 | 0.45 | 0 | 0 | 0 | 0.2 | 0.01 | 0 | 0.02 |
| 3 | 1 | 0.56 | 0.8 | 0.05 | 1.2 | 0 | 0.01 | 0 | 0.02 |
| 4 | 1 | 0.68 | 0 | 0 | 1.6 | 0 | 0.013 | 0.02 | 0 |
| 5 | 1 | 0.75 | 0 | 0 | 0 | 0.5 | 0.013 | 0.02 | 0 |

TABLE 2
Properties of KII-REC PVA and Spectra 900 PE Fibers

| Fiber | Nominal Strength | Diameter | Length | Modulus of Elasticity |
|---|---|---|---|---|
| Type | (MPa) | (μm) | (mm) | (GPa) |
| PVA | 1620 | 39 | 12 | 42.8 |
| PE | 2400 | 38 | 38.1 | 66 |

The mixture was prepared in a Hobart mixer with a planetary rotating blade. Solid ingredients, except fiber, were dry mixed for approximately 1-2 minutes, and then water and the superplasticizer was added and mixed another 2 minutes. The fibers were then slowly added, until all fibers were dispersed into the cementitious matrix. The fresh mixture was cast into plexiglass molds. Specimens were demolded after 24 hours and then cured in sealed bags at room temperature for 7 days. The specimens were then cured in the air until the predetermined testing age of 28 days.

Uniaxial tensile test was conducted to characterize the tensile behavior of the composite. Since some quasi-brittle fiber reinforced concretes show apparent strain hardening behavior under flexural loading, direct uniaxial tensile test is considered the most convincing way to confirm strain hardening behavior of the composite. The coupon specimen used here measures 304.8 mm×76.2 mm×12.7 mm. Aluminum plates were glued to the coupon specimen ends to facilitate gripping. Tests were conducted in an MTS machine with 25KN capacity under displacement control. The test strain rate ranges from 10⁻⁵ to 10⁻¹ s⁻¹, corresponding to quasi-static loading to low speed impact. Two external LVDTs (Linear Variable Displacement Transducer) were attached to specimen surface with a gage length of 100 mm to measure the displacement.

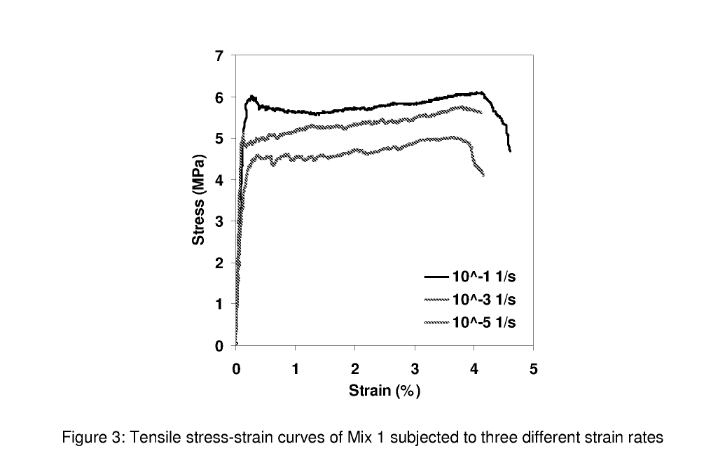

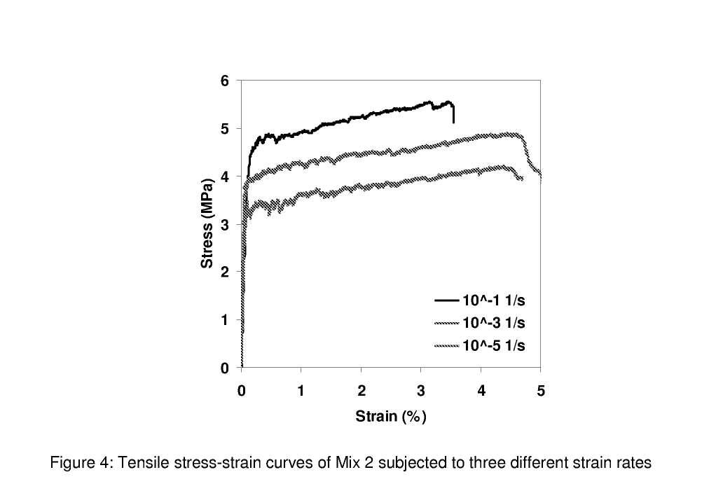

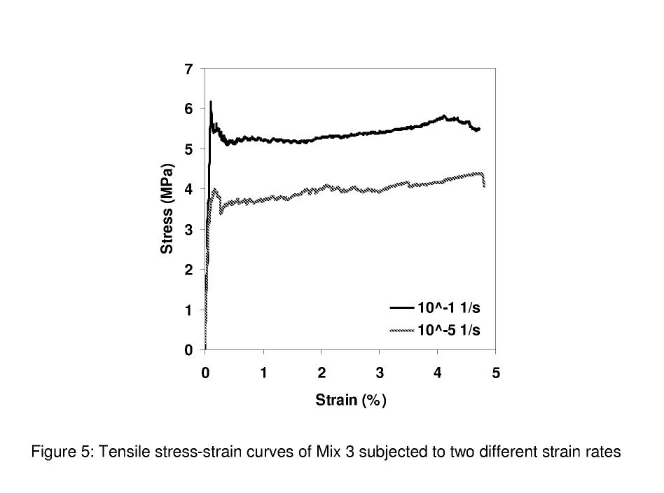

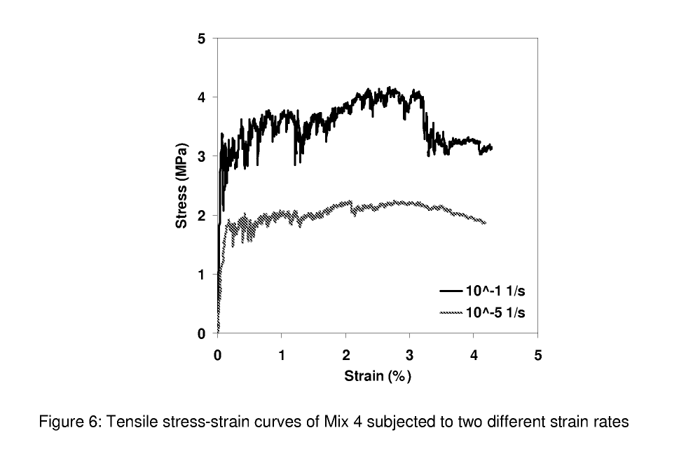

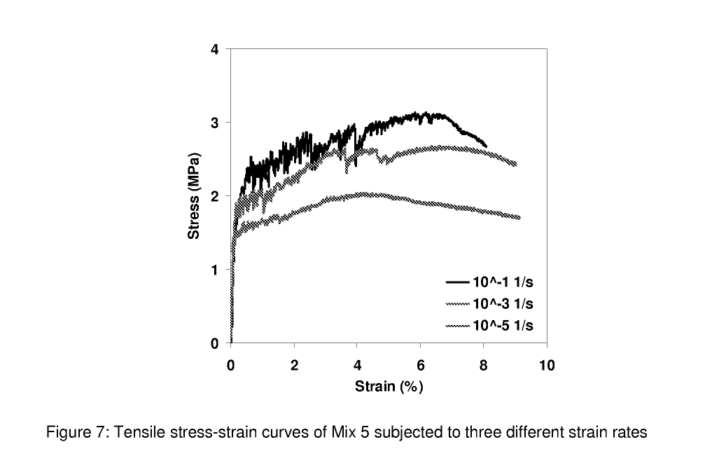

The test results are summarized in Table 3, including tensile strain capacity and strength at the highest test rate, and compressive strength at quasi-static loading for each Example mix. Complete tensile stress versus strain curves of these composites are illustrated in FIGS. 3 to 7, and all of them exhibit significant strain hardening behavior when subjected to strain rate ranges from 10⁻⁵ to 10⁻¹ s⁻¹.

TABLE 3
Properties of Examples

| | Tensile strength | Tensile strain | Compressive strength |
|---|---|---|---|
| Mix No. | (MPa) | capacity (%) | (MPa) |
| 1 | 5.94 | 3.84 | 39.6 |
| 2 | 5.65 | 3.35 | 41.7 |
| 3 | 5.98 | 4.31 | 45.2 |
| 4 | 4.19 | 3.21 | 48.4 |
| 5 | 3.31 | 6.24 | 21.8 |

To demonstrate the impact resistance, Mix 1 was used to build simple structural elements. Drop weight impact tests were then performed to evaluate the impact resistance of simple structural elements in the form of circular plate, beams and steel rebar reinforced beams. In all tests, concrete or mortar specimens were used as controls.

Circular plate specimens were tested under drop weigh impacts to evaluate their impact resistance. Mix 1 and mortar (f_{cube}=35 MPa) were used as materials for the preparation of circular plates. The plates (diameter=350 mm, thickness=13 mm) were supported along the perimeter at a span of 330 mm. The striking mass was a 35 mm, 977 gram steel cylinder. At each test the striking mass was dropped from various heights up to 1.4 m. The dropping heights were 50, 75, 100, 125, and 140 cm and the corresponding strain rates were 0.23, 1.11, 2.05, 3.53 and 4.28 s⁻¹ (striking velocities ranged from 1.2 to 5 m/sec). After each drop the plates were visually examined to determine viability of the next drop.

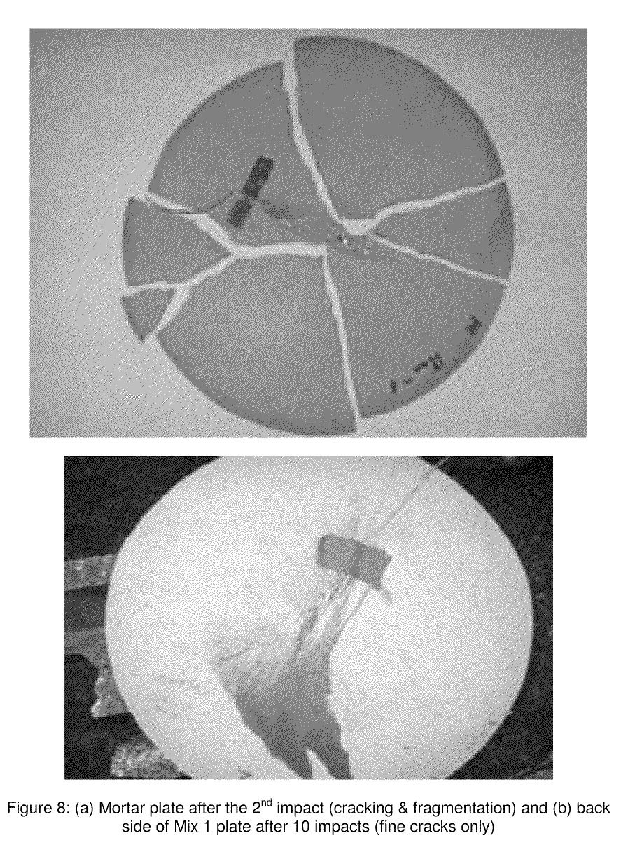

The control mortar plate withstood the first 50-cm drop but failed under the 2^{nd} impact of 75-cm drop (the 2^{nd} impact) with severe cracking and fragmentation (FIG. 8a), whereas the test on Mix 1 plates were aborted after a series of drops (two dropping series of 50, 75, 100, 125 and 140 cm, total 10 impacts) with only minor damage caused. Again, Mix 1 plates showed superior impact resistance when compared with mortar specimens. While the control mortar plate withstood only a single impact, Mix 1 plates withstood all impact levels (i.e. from all drop heights) without significant damage after the first test series (five drops). The Mix 1 specimens remained without major damage and showed significant load carrying capacity in the second series of drops as shown in Table 3. Only fine multiple microcracks were found on the backside of the plates as shown in FIG. 8b.

TABLE 3
Load cell peak impact force of Mix 1 plate

| | Drop Height (cm) | | | | |
|---|---|---|---|---|---|
| | 50 | 75 | 100 | 125 | 140 |
| 1^{st} series | 0.7 kN | 1.8 kN | 2.5 kN | 3.0 kN | 3.1 kN |
| 2^{nd} series | 0.8 kN | 1.8 kN | 1.6 kN | 1.9 kN | 2.2 kN |

Beams and steel rebar reinforced beams measuring 305 mm×76 mm×51 mm (length×height×depth) were tested under three-point-bending drop weight impacts to evaluate their impact resistance. Mix 1 and concrete (f′_{c}=40 MPa) were used as materials for the preparation of beams and steel rebar reinforced beams. In the case of steel rebar reinforced beams, a single 5 mm diameter steel bar with no ribs was used as reinforcement. The steel bar was placed close to the bottom side with a clear cover of 18 mm. The reinforcing ratio of both steel bar reinforce Mix 1 (R/Mix 1) beam and steel bar reinforced concrete beam was 0.5%.

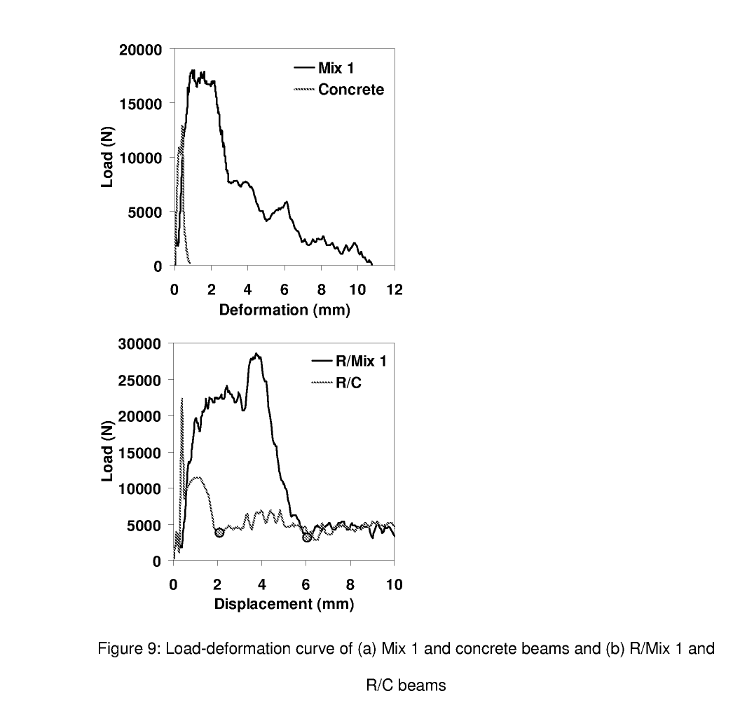

A 50 kg impact tup with flat impact surface was lifted to a height of 50 cm and allowed to drop freely under its free weight onto the center of the specimen. The mass and height were chosen so that the specimen failed in one single impact. The specimens were supported with a span of 254 mm. A steel roller was glued in the middle span and on the top surface of the specimen so that a uniform line load was applied to the specimen when the tup contacted the roller. 1 mm thick hard rubber pads were placed in between the specimen, the roller, and the tup. The rubber pads were meant to eliminate potential inertia effect during impact. FIG. 9 shows the load-deformation curve of concrete, Mix 1, reinforced concrete, and R/Mix 1 beams and Table 4 summarizes their load carry and energy absorption capacity. The energy absorption of beams without reinforcement was the area below the full load-deformation curve until the load is zero. In case of reinforced beams, the failure state was defined as a crack penetrates through the depth of the specimen, which was characterized by a constant load capacity (˜5 kN) due to pullout of steel reinforcing bar (i.e. green dots in FIG. 9b). Therefore, the energy capacity of reinforced concrete and R/Mix 1 beams was the area below the load-deformation curve until the green dots. As can be seen, Mix 1 and R/Mix 1 beams show improved load and energy capacity than that of concrete and reinforced concrete beam, respectively. Interestingly, the load and energy capacity improvement due to reinforcements in Mix 1 specimen is much more significant than that of concrete specimen. This can be attributed to the ultra tensile ductility of Mix 1 material so that compatible deformation between steel reinforcement and Mix 1 in the R/Mix 1 beam can be achieved, and therefore a longer segment of steel yielding. The synergetic interaction between steel reinforcement and ultra ductile Mix 1 material results in a significant increase in the load and energy capacity of R/Mix 1 beams.

TABLE 4
Load and energy capacity of concrete, reinforced concrete, Mix 1,
and R/Mix 1 beams subjected to drop weight impacts

| | | | Improvement | | | Improvement |
|---|---|---|---|---|---|---|
| | | Reinforced | due to | | | due to |
| | Concrete | Concrete | reinforcement | Mix 1 | R/Mix 1 | reinforcement |
| Load capacity | 13 | 22 | 9 | 18 | 29 | 11 |
| (kN) | | | | | | |
| Energy | 4 | 17 | 13 | 69 | 102 | 33 |
| capacity | | | | | | |
| (N-m) | | | | | | |

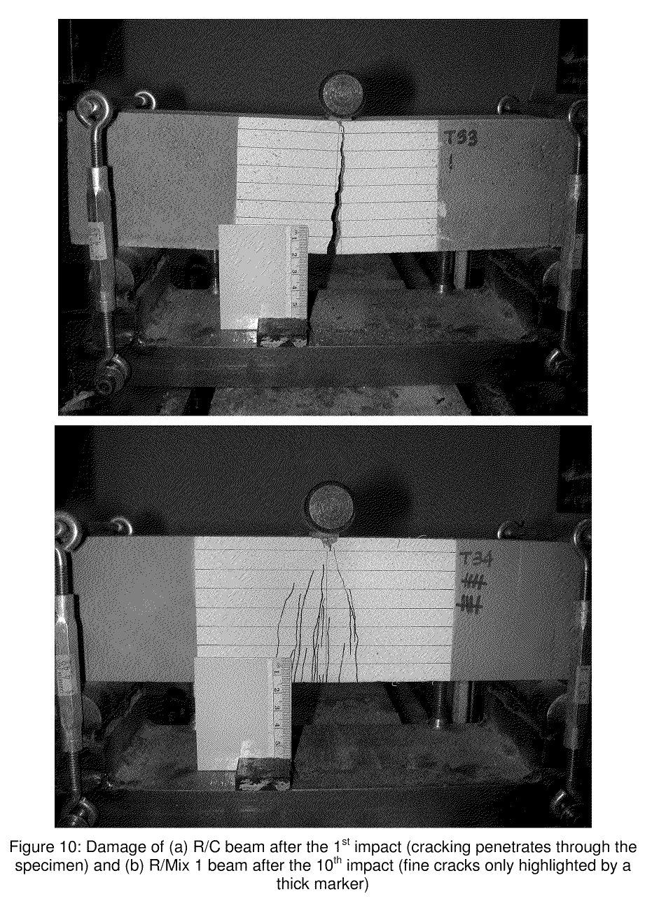

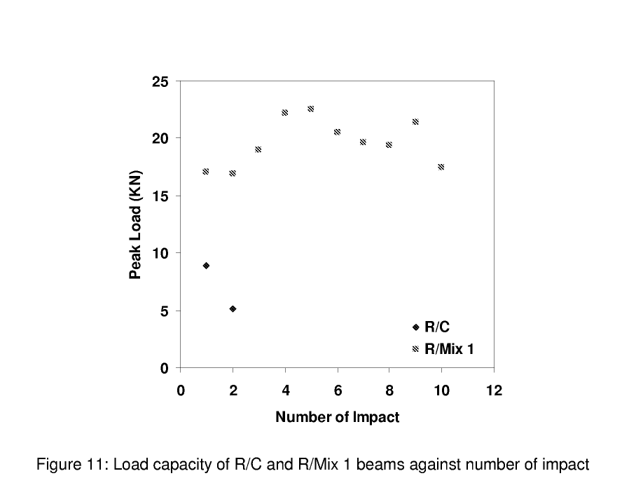

To evaluate the resistance of reinforced concrete and R/Mix 1 beams under multiple impacts, the same test configuration was adopted except that a 12 kg impact tup was chosen and the drop height was 20 cm. Again, the R/Mix 1 beams showed much improved impact resistance than that of reinforced concrete beams. FIG. 10 shows the damage of reinforced concrete and R/Mix 1 after impact testing. As can be seen, one single crack with large crack width appeared in the reinforced concrete beam after the first impact. The crack penetrated through the beam causing severe loss of structural integrity and load carrying capacity. In contrast, only very fine microcracks were found in R/Mix 1 specimen even after 10 impacts. FIG. 11 summarizes the load capacity of reinforced concrete and R/Mix 1 beams in each impact. It was found that reinforced concrete failed after the first impact at about 9 kN (the data point showing load capacity ˜5 kN at the 2^{nd} impact is due to the pullout of reinforcing bar). However, the load capacity of R/Mix 1 remains roughly constant at about 20 kN over the ten impacts.

What is claimed is:

1. A ductile fiber reinforced brittle matrix composite for improving impact resistance of a structure, said composite comprising:
a mixture of
uniformly distributed discontinuous short fibers with a volume fraction from 1% to 4%,
a binder being a cementitious matrix comprising a hydraulic cement, and
water;
said mixture exhibiting strain hardening behavior under tension with at least 1% strain capacity when subjected to static and up to impact loading.

2. The ductile fiber reinforced brittle matrix composite according to claim 1 wherein said uniformly distributed discontinuous short fibers are selected from a group consisting of aramid, polyvinyl alcohol, high modulus polyethylene, and high tenacity polypropylene.

3. The ductile fiber reinforced brittle matrix composite according to claim 1 wherein said uniformly distributed discontinuous short fibers have an average diameter of 10 to 100 micrometer and an average length of 4 to 40 mm.

4. The ductile fiber reinforced brittle matrix composite according to claim 1 wherein said binder is Portland cement.

5. The ductile fiber reinforced brittle matrix composite according to claim 1 wherein the weight ratio of said water to said binder is in the range of 0.2 to 0.6.

6. The ductile fiber reinforced brittle matrix composite according to claim 1 further comprising:
a water reducing agent disposed in said mixture at a weight ratio of said water reducing agent to said binder up to 0.05.

7. The ductile fiber reinforced brittle matrix composite according to claim 1 further comprising:
fine aggregates disposed in said mixture present at a weight ratio of said fine aggregates to said binder up to 2.0.

8. The ductile fiber reinforced brittle matrix composite according to claim 7 wherein said fine aggregates comprises sand.

9. The ductile fiber reinforced brittle matrix composite according to claim 1 further comprising:
lightweight fillers disposed in said mixture with controlled size distribution in a range from 10 to 1000 micrometer.

10. The ductile fiber reinforced brittle matrix composite according to claim 1 further comprising:
lightweight fillers disposed in said mixture with controlled size distribution in a range from 10 to 200 micrometer.

11. The ductile fiber reinforced brittle matrix composite according to claim 1 further comprising:
pozzolanic admixture disposed in said mixture.

12. The ductile fiber reinforced brittle matrix composite according to claim 11 wherein said pozzonlanic admixture comprises at least one of fly ash and silica fume.

13. The ductile fiber reinforced brittle matrix composite according to claim 1 further comprising:
a viscosity modify agent disposed in said mixture.

14. A ductile fiber reinforced brittle matrix composite for improving impact resistance of a structure, said composite comprising:
a mixture of
uniformly distributed discontinuous short fibers with a volume fraction from 1% to 4%,
a binder being a cementitious matrix comprising an inorganic polymer, and
water;
said mixture exhibiting strain hardening behavior under tension with at least 1% strain capacity when subjected to static and up to impact loading.

15. The ductile fiber reinforced brittle matrix composite according to claim 14 wherein said uniformly distributed discontinuous short fibers are selected from a group consisting of aramid, polyvinyl alcohol, high modulus polyethylene, and high tenacity polypropylene.

16. The ductile fiber reinforced brittle matrix composite according to claim 14 wherein said uniformly distributed discontinuous short fibers have an average diameter of 10 to 100 micrometer and an average length of 4 to 40 mm.

17. The ductile fiber reinforced brittle matrix composite according to claim 14 wherein the weight ratio of said water to said binder is in the range of 0.2 to 0.6.

18. The ductile fiber reinforced brittle matrix composite according to claim 14 further comprising:
a water reducing agent disposed in said mixture at a weight ratio of said water reducing agent to said binder up to 0.05.

19. The ductile fiber reinforced brittle matrix composite according to claim 14 further comprising:
fine aggregates disposed in said mixture present at a weight ratio of said fine aggregates to said binder up to 2.0.

20. The ductile fiber reinforced brittle matrix composite according to claim 14 further comprising:
lightweight fillers disposed in said mixture with controlled size distribution in a range from 10 to 1000 micrometer.

21. The ductile fiber reinforced brittle matrix composite according to claim 14 further comprising:
pozzolanic admixture disposed in said mixture.

22. The ductile fiber reinforced brittle matrix composite according to claim 14 further comprising:
a viscosity modify agent disposed in said mixture.
